(19) United States
(12) Patent Application Publication
(10) Pub. No.: US 2023/0334305 A1
(43) Pub. Date: Oct. 19, 2023

(54) Device, System, and Method for Providing an Artificial Neural Network

(71) Applicant: Volkswagen Aktiengesellschaft, Wolfsburg (DE)

(72) Inventor: Heiko Gustav Kurz, Hannover (DE)

(73) Assignee: Volkswagen Aktiengesellschaft, Wolfsburg (DE)

(21) Appl. No.: 18/044,323

(22) PCT Filed: Jul. 22, 2021
(86) PCT No.: PCT/EP2021/070482

§ 371 Date: Mar. 7, 2023

(30) Foreign Application Priority Data
Sep. 9, 2020 (DE) 10 2020 211 341.6

(51) Int. Cl. G06N 3/067; G06N 3/048

(52) U.S. Cl. CPC G06N 3/0675; G06N 3/048

(57) ABSTRACT

The disclosure relates to a device for providing an artificial neural network, comprising at least one optical neuron component for providing at least one neuron of the network. The neuron component is in the form of a nonlinear optical component, in order to output, depending on an input signal of the neuron component having a first frequency, an output signal of the neuron component having a second frequency, wherein the second frequency is different from the first frequency.

### CROSS-REFERENCE TO RELATED APPLICATIONS

This application claims priority to German Patent Application No. DE 10 2020 211 341.6, filed on Sep. 9, 2020 with the German Patent and Trademark Office. The contents of the aforesaid Patent Application are incorporated herein for all purposes.

### TECHNICAL FIELD

The present invention relates to a device for providing an artificial neural network. Furthermore, the invention relates to a system and to a method for this purpose.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The use of artificial neural networks for an increasing number of applications is known from the prior art. For example, in the field of vehicle technology, neural networks can significantly improve the reliability of automatic vehicle functions, for example of driver assistance systems.

The advantages of using neural networks shall be explained below based on an example of a vehicle function of this kind. It is known that detecting the environment in as reliable a manner as possible is indispensable for automatic driving. In this case, the environment of the vehicle is detected by means of sensors, for example radar, lidar, and camera sensors. Furthermore, comprehensive 360° 3D detection of the environment can be used such that all static and dynamic objects can be detected and classified.

For example, in this case, the neural network is able to classify a camera image of a front camera of the vehicle. The individual pixels of the camera image can be assigned a class by means of the neural network (e.g., different classes for the road, road markings, vehicles, pedestrians, and/or vegetation in the environment). The environment can be detected more precisely based on this class information. Pixel-precise assignment of the environment is possible. Furthermore, this information contributes to understanding of the scene, and therefore the vehicle function can act in an adaptive manner.

In particular, the camera plays a key role in redundant, robust environment detection since this type of sensor can precisely measure angles for the environment detection and can be used to classify the environment. However, the processing and classification of the camera images is computationally intensive and architecturally expensive. In particular, 360° 3D environment detection can be problematic in that many individual images must be classified and processed, thus increasing the computing effort.

Conventional high-performance artificial neural networks (NN or ANN for short) already offer the possibility of classifying camera images or data of other sensors with frame rates of less than 10 Hz. As a result, the processing and classification can already be sped up significantly.

However, in some cases, this is still insufficient or requires improvement since modern camera systems work with a frame rate of 30 Hz. For example, reliable environment detection in real time may be required for the vehicle function, and therefore the processing and classification must be performed within a short period of time.

Furthermore, the data load increases with increasing resolution of the camera images. Modern cameras that are compatible with automotive applications already offer a resolution of, for example, around 8 megapixels. The classification of these camera images in the vehicle in real time is currently not possible or is technically very complex. The limiting factor in this case is, in particular, the processor speed, even when using a GPU (graphics processing unit) of modern high-performance computers. Said processor speed may not be sufficient for fully classifying and processing the images in real time, even when the GPU is sped up.

The classification may, in particular, be necessary for scene understanding of the environment, in order to be able to act in accordance with the surroundings of the vehicle during a driving maneuver. Incomplete or incorrect classification therefore poses a problem for automatic driving functions and driver assistance systems.

In summary, it is therefore a problem that conventional electronic neural networks are limited in terms of their computing power by the processor speed, and therefore cannot provide sufficient performance for some applications. High-resolution camera images and sensor data can only be classified by means of neural networks with a reduced frame rate of under 10 Hz, for example.

### SUMMARY

A need exists to at least partially overcome the above-described disadvantages. The need is addressed by a device, by a system, and by a method according to the independent claims. Further features and details are apparent from the respective dependent claims, the description, and the drawings.

Features and details that are described in association with the device(s) may also apply to the described system(s) and described the method(s) and vice versa.

### BRIEF DESCRIPTION OF THE DRAWINGS

FIG. 1 is a schematic representation of a device according to embodiments and a system according to embodiments;

FIG. 2 is a schematic representation for illustrating a method according to embodiments;

FIG. 3 is a schematic representation of an ANN; and

FIG. 4 is a schematic visualization of processing by means of the ANN.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments pertain to an, in particular optical and/or electro-optical, device for providing an artificial neural network (also referred to in the following as ANN or NN for short), in particular an optical ANN.

The device may comprise at least one (or more) optical neuron component(s) for providing at least one neuron of the network (in each case). Accordingly, multiple neuron components can also be provided in the device in order to provide multiple neurons (i.e., for example, in each case one neuron) of the network. The neuron component may be designed to provide the function of a neuron of the ANN in an optical manner. This has the benefit that the ANN at least partially carries out optical processing, and can thus carry out the processing at a higher speed than a conventional electronic ANN.

In contrast to conventional optical approaches in ANNs, it is in particular provided in the device that nonlinear optical effects (i.e., effects of nonlinear optics) are used to provide the function of the neuron and, in particular, the activation function.

In the device, it is in particular provided that the neuron component is in the form of a nonlinear optical component, for example in order to output, depending on an input signal of the neuron component having a first frequency, an output signal of the neuron component having a second frequency, wherein the second frequency is different from the first frequency. In other words, the neuron component may be designed to carry out frequency conversion of the input signal in order to obtain the output signal. The input signal and the output signal may each be in the form of an optical signal, i.e., light or rather a light beam and/or laser beam, for example. This makes it possible to provide the function of a neuron of the ANN in an optical manner. The frequency of the output signal may be dependent on the input signal in a nonlinear manner due to the nonlinear form of the neuron component (e.g., dependent on a parameter of the input signal such as the frequency and/or amplitude and/or phase and/or polarization). This nonlinear dependence makes it possible to provide a function of the neuron, e.g., an activation function. Nonlinear mapping can be done by means of the neuron component, e.g., in the form of a sigmoid function. In other words, the distinction between the second and the first frequency or rather the frequency conversion can be defined by means of a nonlinear dependence of the output signal on the input signal. An increase of the above-mentioned parameter of the input signal, such as the frequency or rather wavelength of the light, can lead to an increase in the frequency or rather wavelength of the output signal according to the sigmoid-typical S-shape due to nonlinear effects. The nonlinear mapping of the neuron component can, for example, be represented in the form y=f(x), and in the case of the sigmoid function as y=sig(x). Here, the parameters x and y may in each case denote the frequencies or rather wavelengths of the light, which can then serve as the input and output signal.

The at least one neuron component may, for example, be designed to provide the at least one neuron of the network and/or be designed as the nonlinear optical component in that the neuron component comprises a material that is transparent and/or causes nonlinear optical effects in the light passing through and/or is an optically nonlinear material in which, in particular, the terms with susceptibilities of the order greater than or equal to 2 do not vanish, i.e., are not equal to zero. The material may, for example, be crystals which have a piezoelectric effect. The input signal of the neural component may, for example, be the light entering the material, which light can then pass through the material (i.e., the medium) and subsequently exit same as the output signal.

An idea underlying the disclosure is, in particular, that the computing speed of an ANN is increased in that optical neurons and optical weights are used for optically processing data. This has the benefit that, in principle, the data can be processed at the speed of light. The data correspond to the input information, i.e., to the input of the ANN, for example image information such as a camera image or the like. The input information may, for example, be received electronically by the device but then converted into optical information in order to obtain the optical input signal of the neuron component. Since a NN (usually) comprises multiple neurons, multiple input signals can accordingly be formed from the input information for multiple neuron components. Furthermore, the input information and/or the optical information obtained therefrom may potentially have been processed and/or weighted previously in order to obtain the at least one input signal. The weighting by means of a weighting component, in particular, will be explained in more detail below.

Optical materials for optical processing can be used for the neurons and/or weights of the ANN, and therefore the ANN can be in the form of an optical ANN. Accordingly, the at least one neuron component may comprise an optical material that provides a nonlinear process while exploiting the nonlinear susceptibility in optical processes of the order ≥2 (e.g. sum frequency generation, difference frequency generation, four-wave mixing processes, Kerr effect, self-phase modulation, etc.). In this way, the nonlinear process of the optical material of the neuron component can execute the function of the neuron. As a result, the input signal or rather the information thereof is processed almost at the speed of light. Furthermore, waveguides may be used as weights of the ANN. Special optical materials can adapt the properties of the waveguide in such a way that a weighting can be effected additively, subtractively, or multiplicatively.

It is conceivable for the device to also comprise at least one (or more) optical weighting component(s) for providing at least one weight of the network (in each case), in order to output an output signal of the weighting component based on a weighting of an input signal of the weighting component, wherein the weighting component for example carries out the weighting of the input signal in an optical manner for this purpose.

The weighting component may, for example, be used to provide the at least one weight in that the weight component comprises a transparent material and/or a doped material and/or a material having a defined absorption of the light passing through. The input signal of the weighting component is, for example, the light entering the material, which passes through the medium of the weighting component and then exits same again, and therefore the output signal of the weighting component can be the exiting light.

Furthermore, the neuron component may be interconnected, in particular optically, with the weighting component, e.g., via a light guide or waveguide, in order to form the input signal of the neuron component at least partially from the output signal of the weighting component and, if applicable, further weighting components. In this way, the weighting component can be used to alter the weights of the neurons. A classic structure of an ANN can therefore be optically constructed by means of the weighting component and the neuron component. A possible topology of the ANN is, in this case, a recurrent NN or a single- or multilayer feed-forward network. The structure of a convolutional neural network (CNN) is also conceivable, but in an optical manner.

The interconnection may also be done in such a way that the output signal of the weighting component corresponds to the input signal of the neuron component to which the weighting component is assigned. A weighting component may also be permanently assigned to a neuron component in order to carry out the weighting of the input of the neuron. This may take place by means of a permanent optical connection between the weighting component and neuron component.

It is possible for all parts of an artificial neural network to be optically mapped by means of the device. For example, the neurons of the ANN may in each case be provided by the neuron component, and/or the weightings may be provided by the weighting component. The weighting requires a linear transformation of the input, such that linear optical effects of the weighting component can be used here. In contrast, the neurons, and in particular the activation function, requires an input to be optically transformed in a nonlinear manner. Accordingly, nonlinear optical effects can be used for the neuron component here.

The provided ANN may be designed to carry out classification and processing of an input, in particular of image information as input information, in real time, and thus within a prescribed limited period of time. This can be achieved in that the ANN is constructed at least in part from optical components that carry out optical processing. In particular, the activation function of the neurons of the ANN may be executed optically. The ANN may therefore be implemented optically. Here, a frequency of the input and/or output signal may be used as the parameter to be processed for the activation function. The frequency therefore constitutes the counterpart for the electrical voltage in the case of electronic implementation of the ANN.

Furthermore, it is conceivable for the weighting component to be designed to linearly transform the input signal of the weighting component in order to generate the output signal of the weighting component. This has the benefit that linear mapping can be carried out optically and thus more quickly by means of, for example, addition or subtraction. For this purpose, an optically active medium having adapted doping can be used for the weighting component, for example.

For example, it may be provided that the weighting component is designed as a waveguide (i.e., optical waveguide) and/or exclusively comprises a waveguide, in order to carry out the weighting of the input signal of the weighting component. A weighting that is technically simple to implement is therefore possible. For example, waveguides with adapted absorber layers or optical parametric amplification may be used for the weighting component in order to obtain a desired weighting of the input signal. The weighting may be provided for each input of a neuron of the ANN, and therefore one weighting component is accordingly provided in each case. A weight can be defined for each weighting component in order to amplify or attenuate the input signal proportionally to the weight or antiproportionally to the weight, respectively. The weights thus determine the degree of the influence the inputs of the neuron have in the calculation of the subsequent activation. An input may have an inhibitory effect or excitatory effect depending on the signs of the weights.

Moreover, it may be possible for the neuron component to be designed to transform the input signal of the neuron component in a nonlinear manner by means of at least one nonlinear optical effect in order to generate the output signal of the neuron component. This allows for optical, and thus quicker, processing by the neuron than in the case of electronic ANNs.

It can be provided that the neuron component is adapted for providing an activation function with the input signal of the neuron component as the input by means of at least one nonlinear optical effect. Linear transformation is often out of the question for the neurons of the ANN, since an activation function should be based on nonlinear mapping. In contrast, linear activation functions are subject to excessive restriction, and are therefore not typically used for an ANN. After the weighting determines the influence of an input signal for the neuron, the output of the neuron can be determined by means of the (nonlinear) activation function. The nonlinear transformation by means of the activation function is made possible by the nonlinear optical properties of the neuron component. The activation function is in the form of a sigmoid function, for example.

Another benefit can be achieved if the at least one nonlinear effect involves at least or exactly one of the following effects:
frequency multiplication, in particular frequency doubling,
sum frequency generation,
difference frequency generation,
an optical parametric process,
optical parametric amplification,
a Kerr effect,
self-phase modulation,
a four-wave mixing process.

It is therefore possible to process the parameter of the frequency of the input and/or output signal of the neuron component in a nonlinear manner in order to provide the function of the neuron, in particular the activation function.

It may also be possible for the neuron component to comprise at least or exactly one of the following materials in order to provide the at least one nonlinear optical effect:
beta-barium borate,
potassium dihydrogen phosphate,
ammonium dihydrogen phosphate,
lithium niobate,
lithium iodate,
silver thiogallate,
silicon,
Si-N,
KTP,
glass,
quartz,
sapphire,
germanium,
MgF,
CaF,
Yb:YAG,
NeYAG,
TiSa, and other laser media.

Furthermore, other materials are also known for providing the nonlinear effect with sufficient strength.

Furthermore, it is conceivable for the neuron component to be designed to output, depending on the input signal of the neuron component having a first amplitude and/or phase, an output signal of the neuron component having a second amplitude and/or phase, wherein the second amplitude and/or phase is different from the first amplitude and/or phase. Accordingly, it is possible to optically process not (only) the frequency as a parameter of the input and/or output signal, but also other parameters such as the amplitude and/or phase. The reliability of the processing can therefore be increased further.

In some embodiments it can be provided for an electronic and/or electro-optical interface assembly, in particular to at least one electronic vehicle component, to be provided, for example in order to provide the artificial neural network in a vehicle. The interface assembly can convert electrical input information (e.g., in the form of digital data and/or electrical signals) into optical information in order to allow for processing by the optical ANN. Subsequently, electrical output information can be formed again from the optical output signals of the neuron components by means of the or another interface assembly. Unlike the input and output signals described, the electrical information is not transmitted optically, but rather via electrical conductors. Accordingly, it can be provided that the device is connected to electronics, in particular a vehicle component, by means of the interface assembly and via cables, in order to electrically transmit the input and output information.

It is also possible if the vehicle is designed as a motor vehicle, in particular a trackless land motor vehicle. The vehicle may, for example, be designed as a hybrid vehicle that comprises an internal combustion engine and an electric machine for traction, or it may be a (purely) electric vehicle or one only having an internal combustion engine. For example, the vehicle may be designed having a high-voltage on-board power supply and/or an electric motor. The vehicle may also be designed as a fuel cell vehicle. The vehicle may also be a passenger car or truck. No internal combustion engine is provided in the vehicle if it is designed as an electric vehicle, and therefore it is driven exclusively using electrical energy.

Some embodiments provide a system, comprising:
a device according to the teachings herein,
at least one vehicle component.

The system provides the same benefits as those described in detail with reference to the aforementioned device.

It may be provided in the system that the system's device comprises an electronic and/or electro-optical interface assembly, in order to:
receive (electrical) input information from the vehicle component, and/or
provide an (optical) input signal for the neural network based on the received input information, and/or
provide (electrical) output information for the vehicle component based on the (optical) output signal of the neuron component.

The input signal may, for example, be transformed in a linear manner by means of a weighting component so as to serve as a weighted input for the neural network. Furthermore, the output information may, if applicable, be formed from the output signal of the last neuron. In the case of multiple neurons, multiple input signals can be formed from the input information.

Furthermore, it is conceivable for the at least one vehicle component to comprise a detection device, for example a camera, in order to generate the input information in the form of image information, and/or wherein the at least one vehicle component comprises a driver assistance system for providing an automatic driving function, for example in order to evaluate the output information by means of the driver assistance system, and in order to use the output information here as a classification of an environment of the vehicle. The use of the optical ANN can allow for evaluation of the complete image information in real time. The detection device comprises, for example, a radar and/or lidar and/or ultrasound, or rather at least one radar sensor and/or lidar sensor and/or ultrasonic sensor, and/or at least one camera, in particular a front camera of the vehicle. The detection device may be designed to detect the surroundings of the vehicle, especially in the direction of travel.

Also part of the present teachings is a method for providing an, in particular optical, artificial neural network. In this regard, it is provided that the following steps are carried out, for example one after the other in the specified order or in any desired order, wherein individual steps can also be repeated:
providing at least one neuron of the network by means of at least one optical neuron component, wherein the neuron component may be in the form of a nonlinear optical component,
outputting an output signal of the neuron component having a second frequency depending on an input signal of the neuron component, wherein the second frequency is different from a first frequency of the input signal.

The method provides the same benefits as those described in detail with reference to the aforementioned device. In addition, the method may be suitable for operating a device according to the present teachings and/or a system according to the present teachings. The system and/or the device may be designed to carry out the steps of the method according to the teachings herein.

Further benefits, features, and details of the invention are apparent from the following description, in which exemplary embodiments are described in detail with reference to the drawings.

In the FIGS., the same reference numerals are used for the same technical features, even of different exemplary embodiments. Specific references to components, process steps, and other elements are not intended to be limiting.

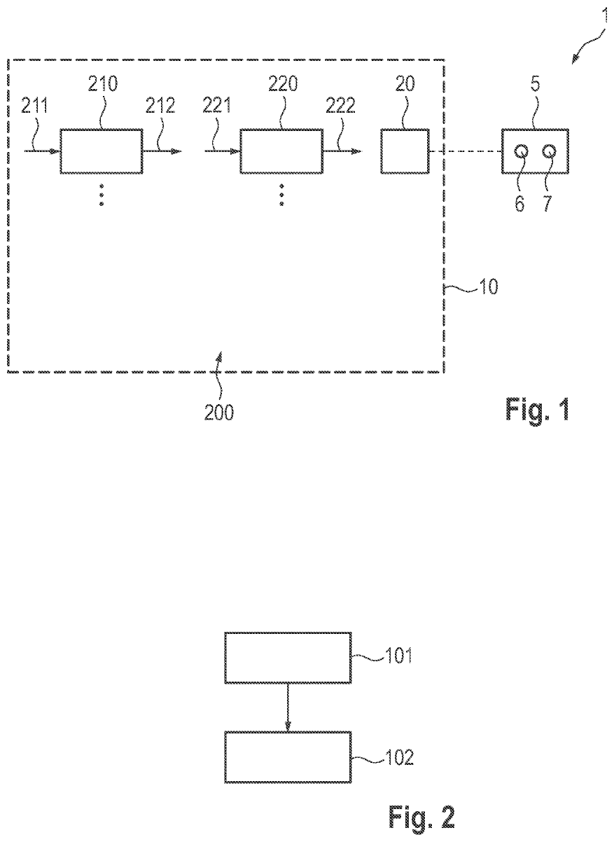

FIG. 1 shows a device 10 for providing an artificial neural network 200. Furthermore, the device 10 is shown as part of a system 1 having an electronic and/or electro-optical interface assembly 20 to at least one electronic vehicle component 5. The at least one vehicle component 5 may comprise a detection device 6 for generating input information 231 in the form of image information and a driver assistance system 7 for providing an automatic driving function, in order to evaluate output information 232 by means of the driver assistance system 7.

The device 10 may comprise at least one optical neuron component 220 for providing at least one neuron of the network 200. Specifically, multiple optical neuron components 220 may be provided in order to implement all neurons of the ANN by means of the neuron components 220.

The neuron component 220 may be in the form of a nonlinear optical component, in order to output, depending on an input signal 221 of the neuron component 220 having a first frequency, an output signal 222 of the neuron component 220 having a second frequency, wherein the second frequency is different from the first frequency. The second frequency may be dependent on a nonlinear relationship between the input and output signal, wherein this relationship is defined by the nonlinear properties of the neuron component 220. For example, in the case of frequency multiplication, in particular frequency doubling, the second frequency may correspond to twice the first frequency. Therefore, a sort of sigmoid function, for example, can be simulated in this way.

The device 10 may further comprise at least one optical weighting component 210 for providing at least one weight of the network 200, in order to output an output signal 212 of the weighting component 210 based on a weighting of an input signal 211 of the weighting component 210. The output signal 212 may in this case correspond to the input signal 221 of the neuron or rather neuron component 220 to which the weighting component 210 is assigned. In this way, the weighting component 210 can carry out the weighting of the input of the neuron and thus determine the degree of influence the inputs of the neuron will have in the calculation of the subsequent activation. The interconnection of the neuron component 220 with the weighting component 210 may be done according to this assignment.

The weighting component 210 may be designed to linearly transform the input signal 211 of the weighting component 210 in order to generate the output signal 212 of the weighting component 210. For this purpose, the weighting component 210 is, for example, designed as a waveguide and/or exclusively comprises a waveguide, in order to carry out the weighting of the input signal 211 of the weighting component 210. In contrast, the neuron component 220 may be designed to transform the input signal 221 of the neuron component 220 (i.e., in particular, the output signal 212 of the weighting component 210) in a nonlinear manner by means of at least one nonlinear optical effect in order to generate the output signal 222 of the neuron component 220. Specifically, the neuron component 220 may be adapted to provide an activation function with the input signal 221 of the neuron component 220 as the input by means of at least one nonlinear optical effect.

FIG. 2 schematically visualizes the steps of a method. In a first method step 101, at least one neuron of the network 200 is provided by means of at least one optical neuron component 220, wherein the neuron component 220 is in the form of a nonlinear optical component. In a second method step 102, an output signal 222 of the neuron component 220 having a second frequency is output depending on an input signal 221 of the neuron component 220, wherein the second frequency of the output signal 222 is different from a first frequency of the input signal 221. The input and output of the neuron component 220 therefore have different frequencies.

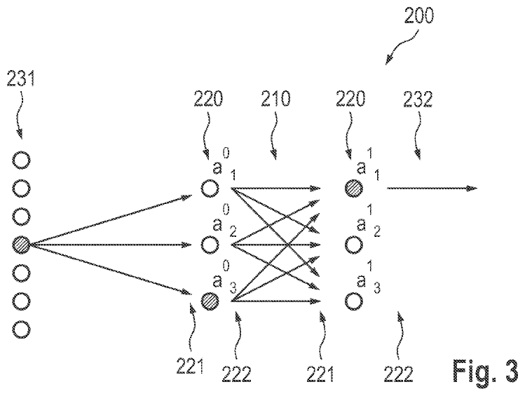

FIG. 3 schematically shows a structure of an optical ANN by way of example. Artificial neural networks are used in automatic driving functions above all for classifying the environment. Here, sensor data (of the input information 231) are forwarded electronically via a weighting (weights) to the neurons a⁰₁, a⁰₂, . . . etc. The output signal 222 of the neurons, and thus the signal 221 forwarded to the neurons a¹₁, a¹₂, . . . of the following layer, is often given by a sigmoid function of the sum of weighted response functions,

a₁¹=σ(Σωᵢaᵢ⁰) (1)

wherein ωᵢ denotes the weights, aᵢ⁰ denotes the neurons, and σ denotes the sigmoid function. The artificial neural network thus forms a function

f(a⁰, . . . ,aⁿ)=(y₀, . . . ,Yₖ) (2)

with k, n∈ [symbol] , wherein the values of the function yᵢ are output as class information (of the output information 232).

Typically, artificial neural networks are implemented on conventional computer architectures which, however, have the disadvantage that they process large quantities of data slowly. An optical ANN can be used instead. The sigmoid function of the neurons may be provided in each case by a neuron component 220 and the weights may be provided in each case by a weighting component 210. Furthermore, the input and output information 231, 233 may be provided by an interface assembly 20.

The use of optical components such as the neuron and/or weighting components 210, 220 offers the possibility of performing the above-mentioned computing operations with light. Therefore, mathematical operations such as addition, subtraction, or multiplication can be achieved by in-phase superposition or amplification and absorption of light waves. A possible optical component is an optical waveguide. For optical neural networks, however, the nonlinear function, i.e., the sigmoid function as in the example above, is of great importance. For this purpose, nonlinear optical processes of a higher order, so-called multiphoton processes, are used during the interaction of light and matter. The use of multiphoton processes can take place or rather be implemented by means of the neuron component 220.

The evolution of the electrical polarization P is an established model for describing multiphoton processes in the interaction of light and matter:

P=ϵ₀[X⁽¹⁾E+X⁽²⁾E²+X⁽³⁾E³+X⁽³⁾+X⁽⁴⁾E⁴+ . . . ] (3)

with P as the electrical polarization, Xⁿ as the electrical susceptibility, E as the electrical field, and ϵ₀ as the dielectric constant.

While the linear term with electric susceptibility X⁽¹⁾ scales linearly with the electrical field, higher order terms X⁽ⁿ⁾ with n>1 exhibit nonlinear proportionality to the electrical field strength. These processes are referred to as multiphoton processes. Here, the number of photons required scales with the order n of X⁽ⁿ⁾. Effects such as frequency doubling or sum and difference frequency generation require two photons, generate photons of a corresponding frequency of the fundamental light frequency, and thus induce second order nonlinearity in the material. Third order effects, such as frequency tripling, the Kerr effect, etc., require three photons for third order frequency conversion; four-wave mixing processes accordingly require four photons, and so on.

These effects of the nonlinear interaction of light and matter offer the possibility of modulating an incident light wave (the input signal 221) in a nonlinear manner, in a comparable manner to the nonlinear modulation of the electrical current by an artificial neuron. Here, the nonlinear material acts as an optical neuron, which is a function of the electrical field, nonlinear or linear susceptibility, and interaction in the material and, for example, outputs frequency, amplitude, or phase information as the value of the function:

f(X⁽ⁿ⁾,Eⁿ,a⁰, . . . ,aⁿ)=(y₁, . . . ,yₖ) (4)

Furthermore, these nonlinear optical effects have a maximum conversion efficiency, and therefore saturation of the converted photons occurs. Therefore, these processes offer the possibility of modulating light waves by means of nonlinear interactions and of representing functions for computing operations, which are comparable to the above-described sigmoid function (or other nonlinear functions). However, these effects are instantaneous, i.e., there is no time delay for the optical computing operation. The use of these optical neural networks therefore makes it possible to process data at the speed of light.

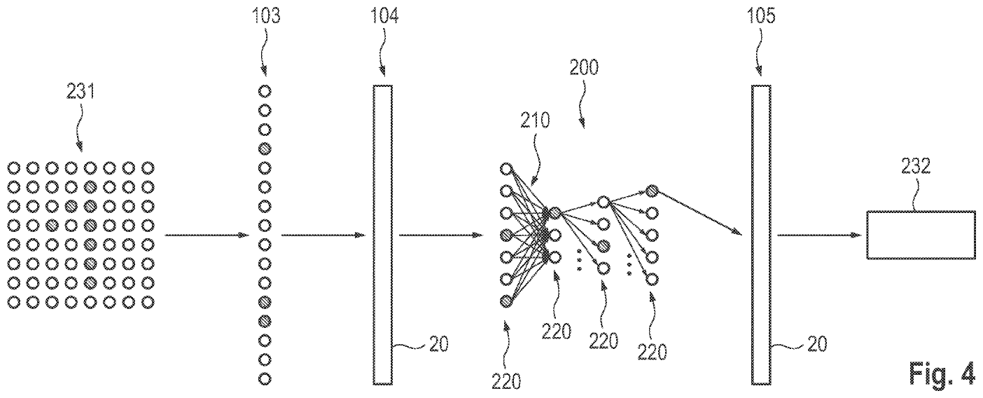

FIG. 4 schematically shows the data processing using an optical neural network. The input information 231, in this case the pixels of an image of a detection device 6, are read out, for example, by means of at least one electro-optical interface assembly 20 in the form of a column vector. Accordingly, the input information 231 can initially be transformed from a matrix into a column vector (step 103). According to step 104, by means of the at least one interface assembly 20, the input information 231 can then be converted from an electrical signal into an optical signal and then transferred, for example, via a waveguide of the weighting component 210. The waveguide can, in this case, serve as an optical weight and transmits the optical signal to an optical neuron, i.e., to the neuron component 220. The neuron can be formed from an optically nonlinear material of the neuron component 220. The response function may emerge as a superposition of the signals of all optical neurons of the ANN, which lead to a nonlinear effect in the material and are transferred to the next layer of neurons via another optical weight. According to step 105, the output signal can be forwarded by means of the at least one electro-optical interface assembly 20 to electronics such as a conventional computer. Therefore, the classification of the input data takes place in a purely optical manner and is provided as an electronic signal for the further data processing.

It can be provided for the training that the output information 232 is forwarded to a processing device (for example a processor, e.g. a GPU). The output information 232 may then be evaluated in order to adapt the optical weights via a feedback loop and in order to optimize the result.

The explanation of the embodiments given in the preceding describes the present invention by various examples. Individual features of the embodiments may be combined freely with one another, to the extent that this is technically feasible, without departing from the scope of the present invention.

### LIST OF REFERENCE NUMERALS

1 System
5 Vehicle component
6 Detection device
7 Driver assistance system
10 Device
20 Interface assembly
101 First method step
102 Second method step
103-105 Additional method steps
200 Artificial neural network
210 Weighting component, first component
211 Input signal of 210
212 Output signal of 210
220 Neuron component, second component
221 Input signal of 220
222 Output signal of 220
231 Input information
232 Output information

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A device for providing an artificial neural network, comprising:
at least one optical neuron component for providing at least one neuron of the network;
wherein the neuron component is in the form of a nonlinear optical component to output, depending on an input signal of the neuron component having a first frequency, an output signal of the neuron component having a second frequency, wherein the second frequency is different from the first frequency.

2. The device claim 1, comprising
at least one optical weighting component configured to output an output signal of the weighting component based on a weighting of an input signal of the weighting component;
wherein the neuron component is interconnected with the weighting component to form the input signal of the neuron component at least partially from the output signal of the weighting component.

3. The device of claim 2, wherein the weighting component is configured to linearly transform the input signal of the weighting component to generate the output signal of the weighting component.

4. The device of claim 2, wherein the weighting component is configured as a waveguide and/or exclusively comprises a waveguide to carry out the weighting of the input signal of the weighting component.

5. The device of claim 1, wherein the neuron component is configured to transform the input signal of the neuron component in a nonlinear manner using at least one nonlinear optical effect to generate the output signal of the neuron component.

6. The device of claim 1, wherein the neuron component is configured to provide an activation function with the input signal of the neuron component as the input by means of at least one nonlinear optical effect.

7. The device of claim 5, wherein the at least one nonlinear effect involves at least one of the following effects:
frequency multiplication,
sum frequency generation,
difference frequency generation,
an optical parametric process,
optical parametric amplification (OPA), and
a Kerr effect.

8. The device of claim 5, wherein the neuron component comprises at least one of the following materials in order to provide the at least one nonlinear optical effect:
beta-barium borate (BBO),
potassium dihydrogen phosphate (KDP),
ammonium dihydrogen phosphate (ADP),
lithium niobate,
lithium iodate,
silver thiogallate,
silicon,
Si—N,
KTP,
glass,
quartz,
sapphire,
germanium,
MgF,
CaF,
Yb:YAG,
NeYAG,
TiSa, and
a laser medium.

9. The device of claim 1, wherein the neuron component is configured to output, depending on the input signal of the neuron component having a first amplitude and/or phase, an output signal of the neuron component having a second amplitude and/or phase, wherein the second amplitude and/or phase is different from the first amplitude and/or phase.

10. The device of claim 1, wherein an electronic and/or electro-optical interface assembly to at least one electronic vehicle component is arranged to provide the artificial neural network in a vehicle.

11. A system, comprising:
the device of claim 1; and
at least one vehicle component.

12. The system of claim 11, wherein the device comprises an electronic and/or electro-optical interface assembly, configured to:
receive electrical input information from the vehicle component;
provide an optical input signal for the neural network based on the received input information; and to
provide electrical output information for the vehicle component based on the optical output signal of the neuron component.

13. The system of claim 12, wherein the at least one vehicle component comprises a detection device to generate the input information in the form of image information, and wherein the at least one vehicle component comprises a driver assistance system for providing an automatic driving function to evaluate the output information by means of the driver assistance system, and to use the output information here as a classification of an environment of the vehicle.

14. A method for providing an artificial neural network, comprising:
providing at least one neuron of the network using at least one optical neuron component, wherein the neuron component is in the form of a nonlinear optical component; and
outputting an output signal of the neuron component having a second frequency depending on an input signal of the neuron component, wherein the second frequency is different from a first frequency of the input signal.

15. The method of claim 14, wherein the method is provided by a device for providing an artificial neural network, comprising at least one optical neuron component for providing at least one neuron of the network; wherein
the neuron component is in the form of a nonlinear optical component to output, depending on an input signal of the neuron component having a first frequency, an output signal of the neuron component having a second frequency, wherein the second frequency is different from the first frequency.

16. The device of claim 3, wherein the weighting component is configured as a waveguide and/or exclusively comprises a waveguide to carry out the weighting of the input signal of the weighting component.

17. The device of claim 2, wherein the neuron component is configured to transform the input signal of the neuron component in a nonlinear manner using at least one nonlinear optical effect to generate the output signal of the neuron component.

18. The device of claim 3, wherein the neuron component is configured to transform the input signal of the neuron component in a nonlinear manner using at least one nonlinear optical effect to generate the output signal of the neuron component.

19. The device of claim 4, wherein the neuron component is configured to transform the input signal of the neuron component in a nonlinear manner using at least one nonlinear optical effect to generate the output signal of the neuron component.

20. The device of claim 2, wherein the neuron component is configured to provide an activation function with the input signal of the neuron component as the input by means of at least one nonlinear optical effect.
